(19) United States
(12) Patent Application Publication
(10) Pub. No.: US 2004/0085303 A1
(43) Pub. Date: May 6, 2004

(54) Display unit, display device and image display system

(75) Inventor: Yasushi Yabuuchi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/682,757

(22) Filed: Oct. 9, 2003

(30) Foreign Application Priority Data
Oct. 31, 2002 (JP) 2002-317966

(51) Int. Cl. G09G 5/00

(52) U.S. Cl. 345/204

(57) ABSTRACT

A liquid crystal display unit has a liquid crystal panel having a display screen consisting of a plurality of pixels, wherein an image is displayed on the display screen when the respective pixel is driven, and a plurality of driving circuits that takes charge of part of the display screen of the liquid crystal panel on a divisional basis into a plurality of divisional areas, and drives the respective pixels of the associated divisional areas thus shared. The liquid crystal display unit further has a driving circuit control section responsive to an effective area signal indicative of an area to be displayed in an image for supplying a power supply to the driving circuits taking charge of part of divisional areas associated with the area indicated by the effective area signal, of the plurality of driving circuits.

### BACKGROUND OF THE INVENTION

1. Field of the Invention

The present invention relates to a display unit having a panel for displaying an image and a driving circuit for driving the panel, a display device, and an image display system.

2. Description of the Related Art

Recently, as an image display device for a computer and the like, there is widely used a display device using a liquid crystal display unit or a PDP (Plasma Display Panel). The display device using a liquid crystal display unit or a PDP is relatively less in power consumption as compared with a display device adopting the conventional other display system, nevertheless it consumes several tens of watts of electric power.

In view of the foregoing, in a transmissive liquid crystal display unit having a backlight, there is developed a display device contributing to a saving power in such a way that when no image signal is transmitted from a computer main frame extending over a predetermined time or more, a mode changes over to a power saving mode in which a luminous intensity of the backlight is decreased.

However, it is impossible to apply this scheme to a reflective liquid crystal display unit and PDP using no backlight.

As a method of saving power other than a method of decreasing a luminous intensity of the backlight, there is a method of contributing to a saving power of a display device in such a manner that an image is displayed on only an active window area on a display screen of a display unit, and black is displayed on areas other than the active window area (for example, Japanese Patent Application Laid Open Gazette Tokukai 2001-125071, page 6, FIG. 18).

According to almost all the latest applications, an active window restricted in size on a display screen is opened to display an image on the area. According to this method, it is possible to expect a saving power to some extent. However, according to this method, black is displayed on areas other than the active window area, and thus an electric power for displaying black is less than that for displaying the usual image. However, power consumption for displaying black cannot be bypassed.

### SUMMARY OF THE INVENTION

In view of the foregoing, it is an object of the present invention to provide a display unit, a display device, and an image display system, which are less in power consumption.

To achieve the above-mentioned object, the present invention provides a display unit comprising: a panel having a display screen consisting of a plurality of pixels in which the plurality of pixels is arranged in such a manner that the plurality of pixels is disposed in each of two directions mutually intersecting, wherein an image is displayed on the display screen when the respective pixel is driven; and the plurality of driving circuits each driving the associated pixel,

wherein the display unit further comprises a driving circuit control section, in response to an effective area signal indicative of a specified area on the display screen, supplying a power supply to the driving circuits which drive pixels in the area indicated by the effective area signal.

Here, it is acceptable that the image signal and the effective area signal are analog signals or digital signals.

According to the display unit according to the present invention as mentioned above, a power supply is supplied to only driving circuits taking charge of part of a so-called active window area in accordance with the effective area signal transmitted from the computer main frame, and a power supply to driving circuits taking charge of part of areas other than the active window area is cut. Thus, it is possible to obtain a display unit less in the power consumption. For example, according to the conventional liquid crystal display unit, one IC driver (the driving circuit) consumes electric power about 5% or more of the entirety of the liquid crystal panel, and thus in the event that the liquid crystal display unit is provided with 15 IC drivers, it is possible to save the power of the maximum about 65% with the small active window. Further, in case of a transmissive liquid crystal display unit, the combination use of the display unit with a backlight system makes it possible to implement a liquid crystal display unit of lower power consumption.

In the display unit according to the present invention as mentioned above, it is preferable that the display unit further comprises a black signal applying section that applies, as a part of the image signal, a signal to display black for pixels of an area portion out of an area indicated by the effective area signal, of a divisional area associated with the area indicated by the effective area signal, to a driving circuit for the divisional area.

This feature makes it possible to let only necessary information stand out, since superfluous information, which may be displayed around the active window area, is covered with black.

In the display unit according to the present invention as mentioned above, it is preferable that the driving circuit control section supplies an electric power to only driving circuits for driving pixels of an area at least partially overlapping with an area starting from a predetermined display start position, the overlapping area having same geometry and area as the area indicated by the effective display area.

This feature makes it possible to open the active window area at a determined position on the display screen. Further, set up of the display start position at the corner of the upper left of the display screen makes it possible to reduce the number of driving circuits necessary for display and thereby saving the superfluous power consumption.

Further, in the display unit according to the present invention as mentioned above, it is preferable that the display unit adopts a system in which the pixels are scanned in a vertical direction and a horizontal direction, and wherein

the driving circuit control section causes the driving circuits to drive the pixels so that the driving circuits, to which the power supply is supplied, are restricted in scanning limit to an area in which pixels are to be driven.

This feature makes it possible to lower a driving speed of the pixels and thereby more lowering the power consumption of the display unit.

To achieve the above-mentioned object, the present invention provides a display device for receiving an image signal representative of an image to display the image represented by the image signal, the display device comprising:

a panel having a display screen consisting of a plurality of pixels in which the plurality of pixels is arranged in such a manner that the plurality of pixels is disposed in each of two directions mutually intersecting, wherein the image is displayed on the display screen when the respective pixel is driven;

the plurality of driving circuits each for driving the associated pixel; and

a driving circuit control section, in response to an effective area signal indicative of a specified area on the display screen, supplying a power supply to the driving circuits which drive pixels in the area indicated by the effective area signal.

According to the display device of the present invention as mentioned above, similar to the display unit of the present invention as mentioned above, it is possible to obtain a display device less in the power consumption.

Further, to achieve the above-mentioned object, the present invention provides an image display system comprising:

a display device that receives an image signal representative of an image to display the image represented by the image signal, the display device comprising: a panel having a display screen consisting of a plurality of pixels in which the plurality of pixels is arranged in such a manner that the plurality of pixels is disposed in each of two directions mutually intersecting, wherein the image is displayed on the display screen when the respective pixel is driven; the plurality of driving circuits each driving the associated pixel; and a driving circuit control section, in response to an effective area signal indicative of a specified area on the display screen, supplying a power supply to the driving circuits which drive pixels in the area indicated by the effective area signal; and

a signal generating apparatus that generates the image signal and the effective area signal and supplies those signals to the display device.

According to the image display system, similar to the display unit of the present invention as mentioned above and the display device of the present invention as mentioned above, it is possible to obtain an image display system less in the power consumption.

Incidentally, with respect to the display device of the present invention and the image display system of the present invention, only the basic forms are shown as described above. However, the display device of the present invention and the image display system of the present invention include all aspects of the display unit as mentioned above as well as the basic forms of the display device of the present invention and the image display system of the present invention.

### BRIEF DESCRIPTION OF THE DRAWINGS

FIG. 1 is a perspective view of a liquid crystal display device having a liquid crystal display unit according to the first embodiment of the present invention, and an image display system.

FIG. 2(a) and FIG. 2(b) are comparison views of a display screen of a liquid crystal display unit according to the first embodiment of the present invention with a display screen of the conventional liquid crystal display unit.

FIG. 3 is a view showing an example of a display according to a liquid crystal display unit of the first embodiment of the present invention.

FIG. 4 is a view useful for understanding an operation of a liquid crystal display unit of the first embodiment of the present invention.

FIG. 5 is a view showing an example of a display according to a liquid crystal display unit of the second embodiment of the present invention.

FIG. 6 is a view showing an example of a display according to a liquid crystal display unit of the third embodiment of the present invention.

FIG. 7 is a view showing an example of a display according to a liquid crystal display unit of the fourth embodiment of the present invention.

FIG. 8 is a view useful for understanding an operation of a liquid crystal display unit of the fourth embodiment of the present invention.

FIG. 9 is a time chart useful for understanding a driving timing in a liquid crystal display unit of the fourth embodiment of the present invention.

### DETAILED DESCRIPTION OF PREFERRED EMBODIMENTS

Hereinafter, there will be described embodiments of the present invention.

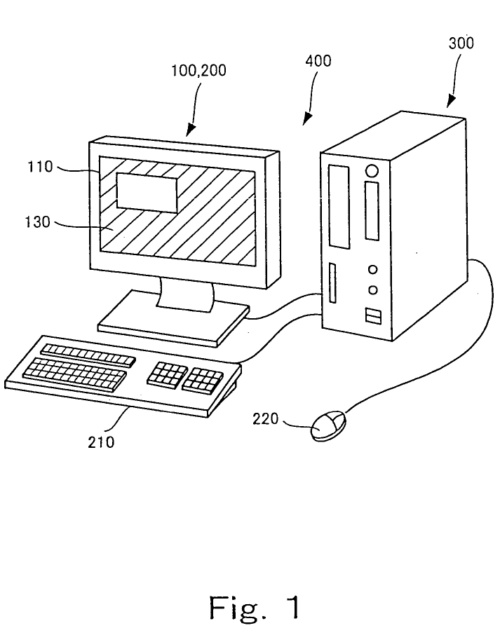

FIG. 1 is a perspective view of a liquid crystal display device having a liquid crystal display unit according to the first embodiment of the present invention, and an image display system.

FIG. 1 shows a perspective view of a liquid crystal display device 200 having a liquid crystal display unit 100 according to the first embodiment of the present invention, and an image display system 400.

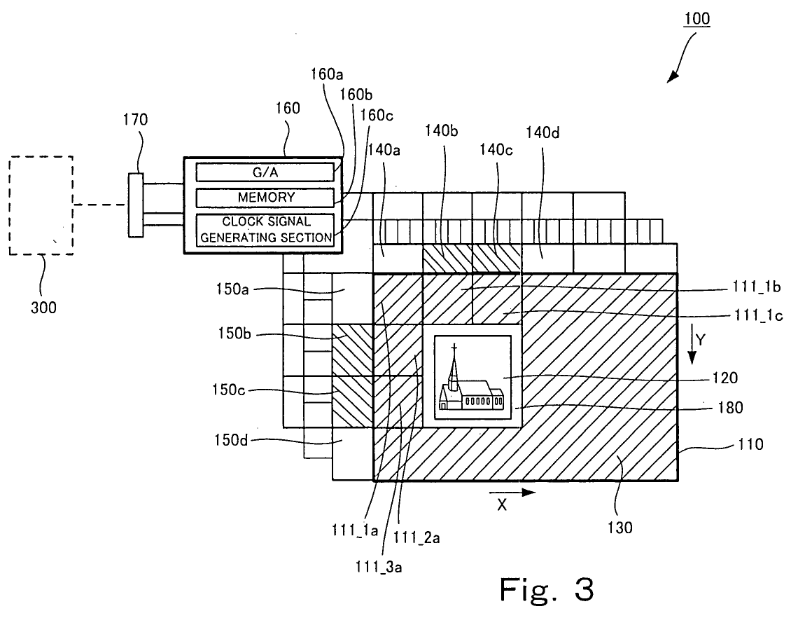

The liquid crystal display unit 100 comprises: a liquid crystal panel 130 having a display screen 110 consisting of a plurality of pixels in which a plurality of pixels is arranged in such a manner that a plurality of pixels is disposed in each of two directions mutually intersecting, wherein an image is displayed on the display screen 110 when the respective pixel is driven; a plurality of driving circuits (here not illustrated, cf. FIG. 3) each for driving the associated pixel; and a driving circuit control section (here not illustrated, cf. FIG. 3) for supplying a power supply to the plurality of driving circuits.

The liquid crystal display device 200 receives an image signal representative of an image and displays the image represented by the image signal. The liquid crystal display device 200 comprises: the liquid crystal display unit 100 having the liquid crystal panel 130, the plurality of driving circuits (here not illustrated, cf. FIG. 3), and the driving circuit control section (here not illustrated, cf. FIG. 3); a power supply circuit; a cover member; and terminals.

The image display system 400 comprises the liquid crystal display device 200, and a computer main frame 300 that creates the image signal and an effective area signal (which will be described later) and supplies those signals to the liquid crystal display device 200. The computer main frame 300 corresponds to an embodiment of the signal generating apparatus referred to in the present invention.

The image display system 400 further comprises a keyboard 210 and a mouse 220 for transmitting information from an operator to the computer main frame 300.

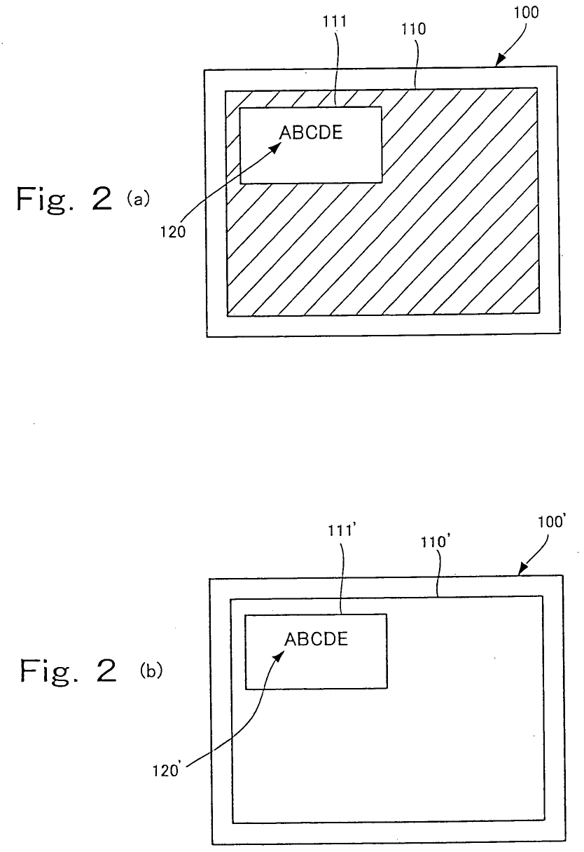

FIG. 2(a) and FIG. 2(b) are comparison views of a display screen of a liquid crystal display unit according to the first embodiment of the present invention with a display screen of the conventional liquid crystal display unit.

FIG. 2(a) shows the display screen 110 of the liquid crystal display unit 100 according to the first embodiment shown in FIG. 1. The display screen 110 is divided into a plurality of areas. Only pixels of a display area 111 to be displayed in image are driven so that an image 120 is displayed. Accordingly, there is no need to supply a power to driving circuits for areas in which no image is displayed, other than driving circuits for the display area 111 to be displayed in image, and thus it is possible to reduce a power consumption of the liquid crystal panel.

For example, when it is assumed that the display screen 110 shown in FIG. 2(a) has effective pixel numbers of 1024 dots in the horizontal direction×768 lines in the vertical direction, and an image 120 is displayed in the display area 111 of 320 dots×240 lines, of the effective pixel numbers of 1024 dots×768 lines, on a pixel number basis,

(320×240)/(1024×768)=0.1024

that is, only about 1/10 of pixels of the total pixels are driven, and thus the power consumption of the liquid crystal display unit is reduced to about 1/10 of a case where the total pixels of the display screen are driven.

However, according to the liquid crystal display unit of the present embodiment, the power supply is not performed in unit of pixel, and is performed in unit of driving circuit for a dividing area consisting of a plurality of pixels. Thus, in the event that a boundary of the active window area is coincident with a boundary of the dividing area, the consumed power will be decreased in the way of the ratio of the number of pixels. However, actually, it often happens that the active window area is not coincident with a boundary of the dividing area, and thus the consumed power is not always decreased in the way of the ratio of the number of pixels.

As mentioned above, the display area 111, which is provided on a part of the display screen, is called as the active window too, and is controlled by an OS (operating system) on the computer. Effective area data representative of the effective display area can be derived from the OS by an application program on the computer, and also can be converted into an effective area signal as will be described later. According to the liquid crystal display unit of the present embodiment, the effective area signal, which is derived and converted in accordance with the application program and the like, is fed to the liquid crystal display unit.

To the contrary, according to the conventional liquid crystal display unit 100′ shown in FIG. 2(b), while a display area 111′, in which an image 120′ similar to FIG. 2(a) is displayed, is opened on a display screen 110′, a power is supplied to all driving circuits in charge of driving for all pixels constituting of the display screen 110′ as well as the display area 111′. Therefore, according to the conventional liquid crystal display unit 100′, a larger amount of electric power is consumed as compared with the liquid crystal display unit 100 according to the present embodiment shown in FIG. 2(a).

FIG. 3 is a view showing an example of a display according to a liquid crystal display unit of the first embodiment of the present invention.

The liquid crystal display unit 100 of the first embodiment shown in FIG. 3 constitutes a liquid crystal display device, which receives an image signal from the signal generating apparatus such as the computer 300 via an interface 170 and displays an image represented by the image signal, and as shown in FIG. 1, constitutes the image display system 400 of the first embodiment together with the computer 300.

The liquid crystal display unit 100 comprises a liquid crystal panel 130, a plurality of driver ICs 140a, 140b, 140c, . . . , 150a, 150b, 150c, . . . , and a driving circuit control section 160. The plurality of driver ICs 140a, 140b, 140c, . . . , 150a, 150b, 150c, . . . in the first embodiment correspond to an embodiment of the driving circuit referred to in the present invention.

The liquid crystal display device corresponding to the liquid crystal display unit 100 of the first embodiment is constructed when the interface 170, a power source circuit, a cover member, terminals and so on (which are not illustrated) are added to the liquid crystal display unit 100.

The liquid crystal panel 130 has the display screen 110 consisting of a plurality of pixels in which a plurality of pixels is arranged in such a manner that a plurality of pixels is disposed in each of two directions X and Y mutually intersecting, wherein an image 120 is displayed on the active window area 180 of the display screen 110 when the respective pixel is driven.

The driver ICs 140a, 140b, 140c, . . . , 150a, 150b, 150c, . . . take charge of part of the display screen 110 of the liquid crystal panel 130 on a divisional basis into a plurality of divisional areas 111_1a, 111_1b, 1111_1c, 111_2a, 111_2b, 111_2c, . . . , and drive the respective pixels of the associated divisional areas thus shared.

The driving circuit control section 160 comprises a G/A (gate array) 160a, a memory 160b, and a clock signal generating section 160c.

The G/A 160a receives an effective area signal representative of an area in which an image is displayed, which is transmitted from the computer main frame 300 via the interface 170, and supplies an electric power to the driver IC for the divisional area associated with the area indicated by the effective area signal, of the plurality of driver ICs. The memory 160b stores information transmitted from the computer main frame 300. The clock signal generating section 160c generates a clock signal representative of a timing of driving a pixel of image signals from a picture plane of image signals. Incidentally, as the memory 160b, for example, a frame memory or the like can be used.

The display screen 110 of the liquid crystal panel 130 is divided into a plurality of divisional areas 111_1a, 111_1b, 111_1c, . . . , 111_2a, 111_2b, 111_2c, . . . , and the respective pixels of those divisional areas are driven by the driver ICs 140a, 140b, 140c, . . . , which are arranged in the X-direction, the driver ICs 150a, 150b, 150c, . . . , which are arranged in the Y-direction.

Next, there will be explained an operation of the liquid crystal display unit of the first embodiment of the present invention.

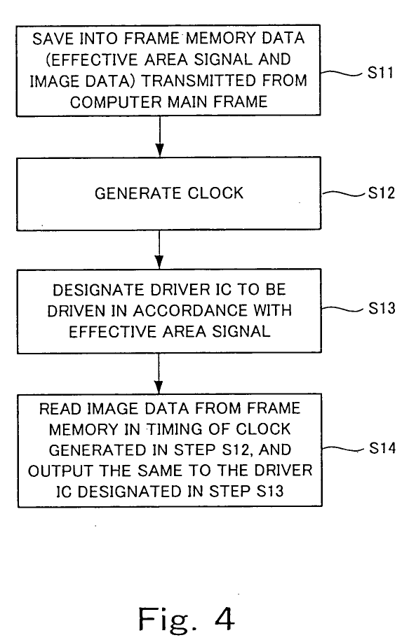

FIG. 4 is a view useful for understanding an operation of the liquid crystal display unit of the first embodiment of the present invention.

When an image signal and an effective area signal representative of an effective display area for image display are transmitted from the computer frame 300 (cf. FIG. 3) via the interface 170 to the driving circuit control section 160 of the liquid crystal display unit 100, those signals are temporarily saved in the memory 160b of the driving circuit control section 160 (step S11).

The image signal includes image data representative of a color of an image, a Vsync signal (vertical synchronization signal) for controlling a scanning start timing of the display screen 110 of the liquid crystal panel 130, and a Hsync signal (horizontal synchronization signal) for controlling a scanning start timing of one line of the display screen 110. The clock signal generating section 160c generates a clock (a clock signal) indicative of a timing of driving a pixel of image signals from a picture plane of image signals (a step S12).

The clock signal is determined in the manner as set forth below. For example, in case of the effective data area 320×240 dots, if one frame frequency is 60 Hz,

One line frequency=60 Hz×240 lines=14.4 KHz

Accordingly,

One dot frequency=14.4 KHz×320 dots 4.6 MHz

The G/A 160a (cf. FIG. 3) designates, in accordance with the effective area signal, the driver ICs (e.g. the driver IC 140b and the driver IC 140c in FIG. 3) associated with the starting point and the terminal point in the X-direction displaying an image from among a plurality of driver ICs arranged in the X-direction, and designates, in accordance with the effective area signal, the driver ICs (e.g. the driver IC 150b and the driver IC 150c in FIG. 3) associated with the starting point and the terminal point in the Y-direction displaying an image from among a plurality of driver ICs arranged in the Y-direction, so that the electric power is supplied to the respective driver ICs from the driver IC 140b and the driver IC 150b, which are associated with the starting points in the X-direction and the Y-direction, respectively, up to the driver IC 140c and the driver IC 150c, which are associated with the terminal points in the X-direction and the Y-direction, respectively (a step S13).

Thus, the driver ICs associated with the effective display area become an operative state, and image data 505 stored in the memory 160b is read in form of image data 506 in accordance with the Vsync signal, the Hsync signal, and the clock generated in the step S12. The image data 506 is outputted to the activated driver ICs (a step S14).

As a result, the image 120 is displayed on the active window area 180 (cf. FIG. 3).

Next, there will be explained the second embodiment of the display unit of the present invention.

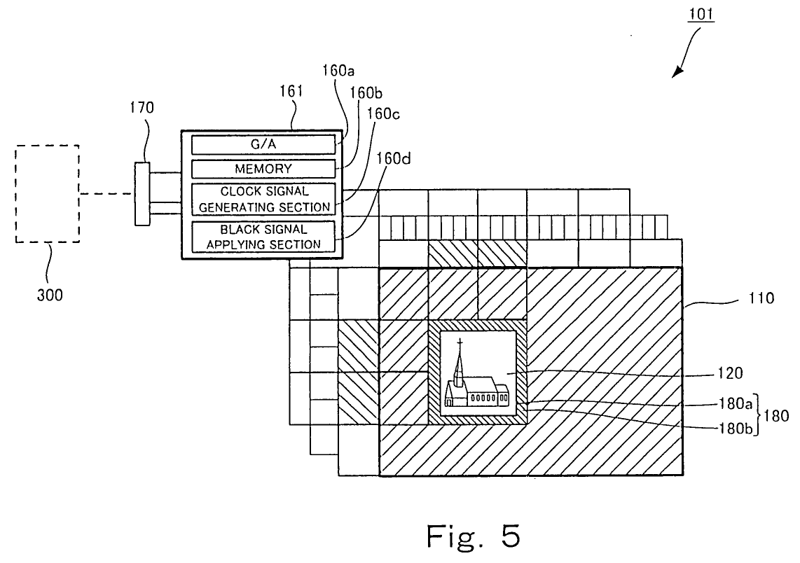

FIG. 5 is a view showing an example of a display according to a liquid crystal display unit of the second embodiment of the present invention.

A liquid crystal display unit 101 of the second embodiment of the present invention shown in FIG. 5 is provided with a driving circuit control section 161 in stead of the driving circuit control section 160 of the liquid crystal display unit 100 shown in FIG. 3. All the structural elements other than the driving circuit control section 161 are the same as those of the liquid crystal display unit 100 shown in FIG. 3.

The driving circuit control section 161 is provided with a black signal applying section 161d as well as the G/A 160a, the memory 160b, and the clock signal generating section 160c, which are the same as those in the liquid crystal display unit 100 of the first embodiment.

The black signal applying section 161d applies, as a part of the image signal, a signal to display black for pixels of an area 180b out of an area 180a indicated by an effective area signal, of a divisional area 180 associated with the area indicated by the effective area signal, to a driving circuit for the divisional area 180.

According to the liquid crystal display unit 101 of the second embodiment, black is displayed on the edge area 180b out of the area 180a for display of the image 120, of the divisional area 180, so that superfluous images of the edge portion of the image 120 are suppressed, and thus it is possible to let the image 120 displayed on the area 180a stand out.

Next, there will be explained the third embodiment of the display unit of the present invention.

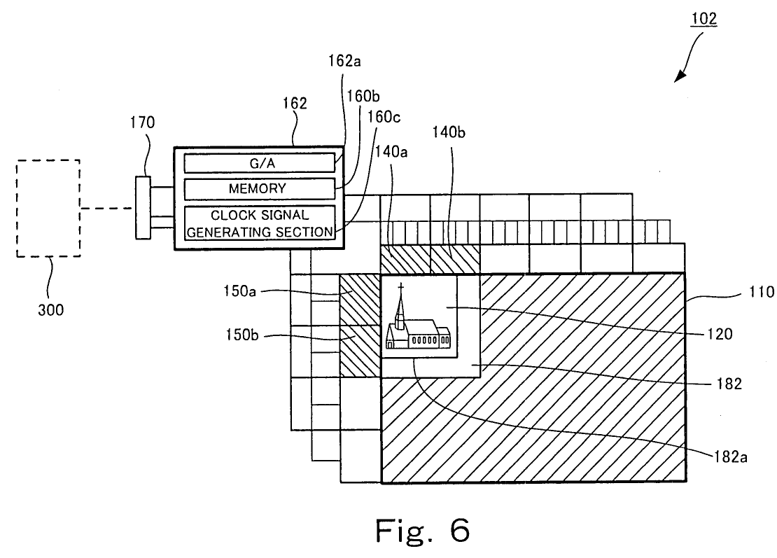

FIG. 6 is a view showing an example of a display according to a liquid crystal display unit of the third embodiment of the present invention.

A liquid crystal display unit 102 of the third embodiment of the present invention shown in FIG. 6 is provided with a driving circuit control section 162 in stead of the driving circuit control section 160 of the liquid crystal display unit 100 shown in FIG. 3. All the structural elements other than the driving circuit control section 162 are the same as those of the liquid crystal display unit 100 shown in FIG. 3.

The driving circuit control section 162 is provided with a G/A 162a that is different from the G/A 160a in the liquid crystal display unit 100 of the first embodiment, the memory 160b, and the clock signal generating section 160c, which are the same as those in the liquid crystal display unit 100 of the first embodiment.

The G/A 162a receives an effective area signal representative of an area in which an image is displayed, which is transmitted from the computer main frame 300 via the interface 170, and supplies an electric power to only a driving circuit for a divisional area that partially overlaps with at least an area starting from a predetermined display start position on the display screen 110, having the same geometry and area as the area indicated by the effective area signal.

That is, according to the driving circuit control section 162 of the third embodiment, the G/A 162a supplies an electric power to four driving circuits 140a, 140b, 150a, and 150b taking charge of part of a divisional area 182 overlapping with an area 182a starting from a predetermined display start position, for example, coordinates (0,0), on the display screen 110. The divisional area 182 has the same geometry and area as the divisional area 180 shown in FIG. 3, and is different from the effective display area only in the display start position.

In this manner, according to the liquid crystal display unit 102 of the third embodiment, it is possible to display the active window at the determined position on the display screen 110. Thus, it is possible to reduce the number of the driving circuits necessary for display and thereby saving superfluous power consumption.

Next, there will be explained the fourth embodiment of the display unit of the present invention.

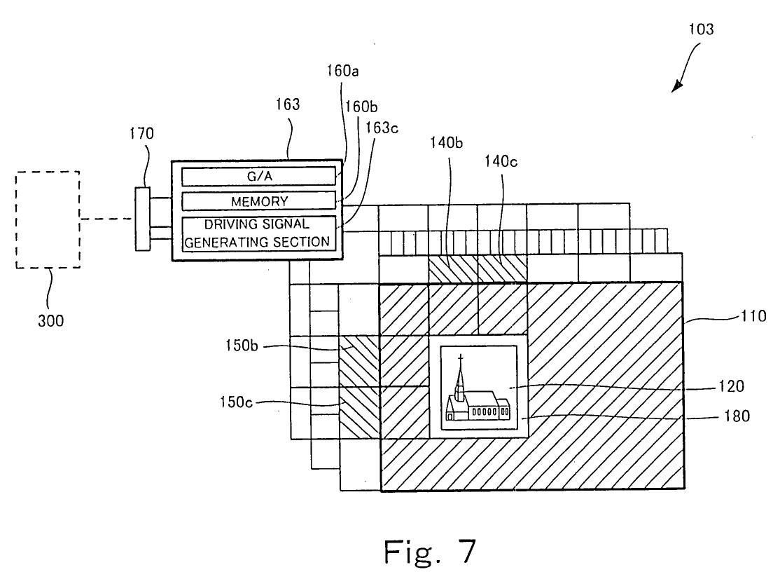

FIG. 7 is a view showing an example of a display according to a liquid crystal display unit of the fourth embodiment of the present invention.

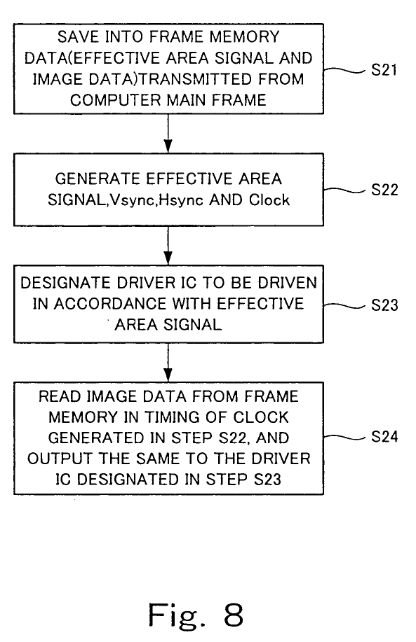

FIG. 8 is a view useful for understanding an operation of a liquid crystal display unit of the fourth embodiment of the present invention.

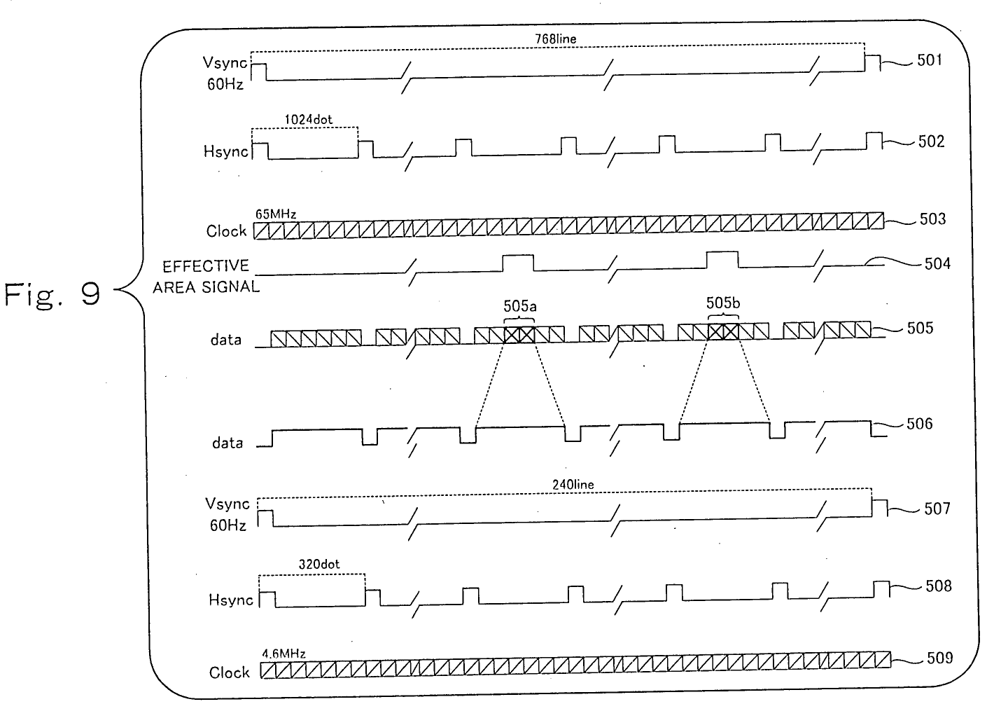

FIG. 9 is a time chart useful for understanding a driving timing in a liquid crystal display unit of the fourth embodiment of the present invention.

A liquid crystal display unit 103 of the fourth embodiment shown in FIG. 7 adopts, as a system for displaying an image, a system in which pixels are scanned in a vertical direction and a horizontal direction to display an image. The liquid crystal display unit 103 of the fourth embodiment of the present invention shown in FIG. 7 is provided with a driving circuit control section 163 in stead of the driving circuit control section 160 of the liquid crystal display unit 100 shown in FIG. 3. All the structural elements other than the driving circuit control section 163 are the same as those of the liquid crystal display unit 100 shown in FIG. 3.

The driving circuit control section 163 is provided with a driving signal generating section 163c as well as the G/A 160a, and the memory 160b, which are the same as those in the driving circuit control section 160 shown in FIG. 3.

The driving signal generating section 163c generates a Vsync signal 507 and a Hsync signal 508 for providing a scan to display on a display screen only effective data 505a and 505b associated with the effective area signal 504 received from the computer main frame, and generates new image data 506 consisting of only the effective data 505a and 505b associated with the effective area signal 504, and a clock 509 issuing instructions of timing of deriving of data for pixels consisting of the image data 506 to the respective driving circuits.

Next, there will be explained an operation of the liquid crystal display unit 103 of the fourth embodiment referring to the flowchart shown in FIG. 8.

When the image signal and the effective area signal are transmitted from the computer main frame 300 (cf. FIG. 7) via the interface 170 to the driving circuit control section 163 of the liquid crystal display unit 103, those signals are temporarily stored in the memory 160b of the driving circuit control section 160 (a step S21).

As shown in FIG. 9, the image signal includes a Vsync signal 501 for controlling a scanning start timing of the display screen 110 of the liquid crystal panel 130, a Hsync signal 502 for controlling a scanning start timing of one line of the display screen 110, and image data 505.

The clock signal generating section 160c generates the Vsync signal 507 and the Hsync signal 508 for providing a scan to display on a display screen only effective data 505a and 505b associated with the effective area signal 504 of the image data 505 transmitted from the computer main frame 300, in stead of the Vsync signal 501 and the Hsync signal 502, and generates new image data 506 consisting of only the effective data 505a and 505b associated with the effective area signal 504 of the image data 505 transmitted from the computer main frame 300, and a clock 509 (frequency: 4.6 MHz) issuing instructions of timing of deriving of data for pixels consisting of the image data 506 to the respective driving circuits (a step S22).

The G/A 160a (cf. FIG. 7) designates, in accordance with the effective area signal, the driver ICs (e.g. the driver IC 140b and the driver IC 140c in FIG. 7) associated with the starting point and the terminal point in the X-direction displaying an image from among a plurality of driver ICs arranged in the X-direction, and designates, in accordance with the effective area signal, the driver ICs (e.g. the driver IC 150b and the driver IC 150c in FIG. 7) associated with the starting point and the terminal point in the Y-direction displaying an image from among a plurality of driver ICs arranged in the Y-direction, so that the electric power is supplied to the respective driver ICs from the driver IC 140b and the driver IC 150b, which are associated with the starting points in the X-direction and the Y-direction, respectively, up to the driver IC 140c and the driver IC 150c, which are associated with the terminal points in the X-direction and the Y-direction, respectively (a step S23).

Thus, the driver ICs associated with the effective window area 180 become an operative state, and image data 505 stored in the memory 160b is read in form of image data 506 in accordance with the Vsync signal 507, the Hsync signal 508, and the clock 509 generated in the step S22. The image data 506 is outputted to the activated driver ICs (a step S24).

As a result, the image 120 is displayed on the active window area 180 (cf. FIG. 7).

According to the liquid crystal display unit of the fourth embodiment, for example as shown in FIG. 9, in case of the display screen of 240 lines×320 dots, the frequency of the clock 509 is 4.6 MHz. This is remarkably lowered as compared with 65 MHz of the frequency of the clock 503 in case of the display screen of 768 lines×1024 dots in the first embodiment.

Incidentally, the frequency of the clock 503 is determined in the manner as set forth below. That is, in case of the usual 1024×768 dots of liquid crystal display unit, the general timing is expressed by

Vertical period: 768+38 lines=806 lines

Horizontal period: 1024+320 dots=1344 dots

Where 38 lines and 320 dots are return period correspondence.

Accordingly, the frequency of the clock signal is expressed by

60 Hz×806 lines×1344 dots≈65 MHz

Thus, when the frequency of the clock signal is lowered, a scanning speed is lowered and thereby lightening the burden imposed on the driving circuit, and as a result, it is possible to reduce the power consumption.

Incidentally, according to the embodiments of the present invention as mentioned above, there are shown the examples in which the signal generating apparatus (the computer) referred to in the present invention generates the image signal and the effective area signal and supplies those signals to a liquid crystal display device. However, it is acceptable that the liquid crystal display device generates the effective area signal. For example, there is provided such an arrangement that a liquid crystal display device is provided with instruction means for issuing instructions of display of an active window on a predetermined area of the display screen in accordance with an operation of an operator, so that the liquid crystal display device generates an effective area signal to display an image on the designated area. This arrangement makes it possible to display an image at a desired position, such as the center of the display screen and the upper left.

Each of the liquid crystal display units of the above-mentioned embodiments has an interface of an analog display compatibility system in which a display screen is scanned in accordance with a vertical synchronization signal and a horizontal synchronization signal transmitted from the computer main frame so that the liquid crystal display units can be used as a so-called analog system of display. However, a display unit of the present invention is not restricted to this system and is also applicable to a display unit having a so-called digital system-dedicated interface.

As mentioned above, according to a display unit, a display device, and an image display system of the present invention, it is possible to implement a display unit, a display device, and an image display system which are extremely less in power consumption, wherein an electric power is supplied to only driving circuits for an effective area according to an effective area signal transmitted from a signal generating apparatus of a computer main frame, and power supply to driving circuits for areas other than the effective area is not performed.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A display unit comprising: a panel having a display screen consisting of a plurality of pixels in which the plurality of pixels is arranged in such a manner that the plurality of pixels is disposed in each of two directions mutually intersecting, wherein an image is displayed on the display screen when the respective pixel is driven; and the plurality of driving circuits each driving the associated pixel,
wherein the display unit further comprises a driving circuit control section, in response to an effective area signal indicative of a specified area on the display screen, supplying a power supply to the driving circuits which drive pixels in the area indicated by the effective area signal.

2. A display unit according to claim 1, wherein the display unit further comprises a black signal applying section that applies, as a part of the image signal, a signal to display black for pixels of an area portion out of the area indicated by the effective area signal, of a divisional area associated with the area indicated by the effective area signal, to the driving circuit for the divisional area.

3. A display unit according to claim 1, wherein the driving circuit control section supplies the electric power to only driving circuits for driving pixels of an area at least partially overlapping with an area starting from a predetermined display start position, the overlapping area having same geometry and area as the area indicated by the effective display area.

4. A display unit according to claim 1, wherein the display unit adopts a system in which the pixels are scanned in a vertical direction and a horizontal direction, and wherein
the driving circuit control section causes the driving circuits to drive the pixels so that the driving circuits, to which the power supply is supplied, are restricted in scanning limit to an area in which pixels are to be driven.

5. A display device for receiving an image signal representative of an image to display the image represented by the image signal, the display device comprising:
a panel having a display screen consisting of the plurality of pixels in which the plurality of pixels is arranged in such a manner that the plurality of pixels is disposed in each of two directions mutually intersecting, wherein the image is displayed on the display screen when the respective pixel is driven;
the plurality of driving circuits each driving the associated pixel; and
a driving circuit control section, in response to an effective area signal indicative of a specified area on the display screen, supplying a power supply to the driving circuits which drive pixels in the area indicated by the effective area signal.

6. An image display system comprising:
a display device that receives an image signal representative of an image to display the image represented by the image signal, the display device comprising: a panel having a display screen consisting of the plurality of pixels in which the plurality of pixels is arranged in such a manner that the plurality of pixels is disposed in each of two directions mutually intersecting, wherein the image is displayed on the display screen when the respective pixel is driven; the plurality of driving circuits each driving the associated pixel; and a driving circuit control section, in response to an effective area signal indicative of a specified area on the display screen, supplying a power supply to the driving circuits which drive pixels in the area indicated by the effective area signal; and
a signal generating apparatus that generates the image signal and the effective area signal and supplies those signals to the display device.
